(19) United States
(12) Patent Application Publication
(10) Pub. No.: US 2009/0074149 A1
(43) Pub. Date: Mar. 19, 2009

(54) MEDICAL DIAGNOSTIC APPARATUS AND HOSE SUITABLE FOR GUIDING CONNECTIONS IN A MEDICAL DIAGNOSTIC APPARATUS

(75) Inventor: Adrianus Van Der Ende, Son en Breugel (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V., Eindhoven (NL)

(21) Appl. No.: 12/300,869

(22) PCT Filed: May 14, 2007
(86) PCT No.: PCT/IB2007/051803

§ 371 Date: Nov. 14, 2008

(30) Foreign Application Priority Data
May 17, 2006 (EP) 06114090.1

(51) Int. Cl. H05G 1/02; H05G 1/00

(52) U.S. Cl. 378/197; 378/204

(57) ABSTRACT

The invention relates to a medical diagnostic apparatus (1) and to a hose (21) suitable for guiding connections in a medical diagnostic apparatus. The medical diagnostic apparatus (1) comprises a frame (5), a rotatable support (3), at least one connection extending between the frame and the rotatable support, and a hose (21) for guiding this connection. The hose (21) is provided with a chain (29) of reinforcement elements (31). The chain (29) extends mainly in the longitudinal direction of the hose (21). In the chain (29) the reinforcement elements (31) are connected to each other. These reinforcement elements (31) can also be rotated with respect to each other about an axis which is perpendicular to the longitudinal axis of the hose (21), while they are substantially rigidly connected in a direction along their rotation axis. The chain (29) of reinforcement elements (31) serves as a backbone in the hose (21) and provides a certain degree of rigidity to the hose while maintaining an optimum freedom of movement of the support (3) with respect to the frame (5) of the medical diagnostic apparatus (1).

The invention relates to a medical diagnostic apparatus comprising a frame, a rotatable support, at least one connection extending between the frame and the support, and a hose for guiding said connections.

The invention also relates to a hose suitable for guiding at least one connection in a medical diagnostic apparatus.

A medical diagnostic apparatus of the kind mentioned in the opening paragraph is known from U.S. Pat. No. 4,288,700. The known medical diagnostic apparatus is an X-ray apparatus provided with an L-shaped arm. The L-shaped arm comprises a portion extending in horizontal direction, which portion is placed on the floor, and a portion extending in vertical direction. The L-shaped arm is capable of rotation about a vertical axis. The known X-ray apparatus is further provided with a U-shaped arm. This U-shaped arm comprises a base portion that extends in radial direction and is connected to the vertical portion of the L-shaped arm and two end portions which extend in axial directions. The U-shaped arm can rotate about a horizontal axis that extends through the point where the U-shaped arm is connected to the L-shaped arm. The U-shaped arm is provided with an X-ray source at one end portion and with an image intensifier at the other end portion. The X-ray source is placed in line with the image intensifier such that the X-ray radiation provided by the X-ray source can be detected by the image intensifier. A patient to be diagnosed can be placed between the X-ray source at the one end portion of the U-shaped arm and the image intensifier at the other end portion of the U-shaped arm. The combination of an L-shaped arm and a U-shaped arm provides the X-ray source and the image intensifier with a wide angular range with respect to the patient, which renders it possible to examine the patient from substantially any perspective desired. Such a wide angular range is also important in making 3D reconstructions of the patient. It is generally known that the quality of a 3D reconstruction is better as the angular range is wider.

The known X-ray apparatus is also provided with a device for guiding a set of cables that run to or from the X-ray apparatus. This device achieves that the set of cables can be freely moved without a mechanical tension building up in the set of cables during use of the X-ray apparatus. This serves to prevent that a usually accurate positioning of the X-ray source and image intensifier relative to the patient is disturbed due to a mechanical tension building up in the set of cables. The device also achieves that the cables do not interfere with the medical staff, the patient, and the movement of the X-ray apparatus. The device furthermore provides the cables with a protection, so that they are less vulnerable, and the device gives the X-ray apparatus an aesthetically more pleasing appearance than would be the case with an X-ray apparatus without such a device.

For this purpose, the device comprises a first support part that extends mainly in a horizontal direction and that can rotate about a first vertical shaft that is mounted to the ceiling above the X-ray apparatus. At some distance away from this first vertical shaft, a second vertical shaft is attached to the ceiling about which a swivel mechanism can rotate. This swivel mechanism ensures that no mechanical tension can build up in the set of cables as a result of torsion. The set of cables running to and from the X-ray apparatus extends through the first support part and the swivel mechanism to or from several electrical appliances present elsewhere in the room in which the X-ray apparatus is located. The first support part comprises an upper guide duct half and a lower guide duct half which can move relative to one another by means of a hinge mechanism. The upper guide duct half and the lower guide duct half can be fixed relative to one another by means of a screw connection such that they form a guide duct through which a set of cables can be guided to and from the X-ray apparatus. The hinge mechanism provides a comparatively easy access to the set of cables running through the guide duct. This is especially important for servicing purposes. A second support part is fastened to the upper guide duct half of the first support part. This second support part comprises a rigid, curved arm to which several guide elements (cable-surrounding split clamps) are fastened so as to guide the set of cables running to or from the X-ray apparatus in a controlled manner to or from the guide duct of the first support part. The set of cables is surrounded by a flexible tube or hose between the swivel mechanism and the first support part. The guide duct of the first support part and the second support part are also surrounded by a flexible tube or hose that is provided between the first support part and the L-shaped arm of the X-ray apparatus. The set of cables is protected by these flexible tubes or hoses and the guide duct, the second support part, and the set of cables are hidden from view thereby.

A disadvantage of the known X-ray apparatus with a device for guiding a set of cables running to or from the X-ray apparatus as disclosed in U.S. Pat. No. 4,288,700 is that the construction of this device is comparatively complicated and is to be attached to the ceiling above the X-ray apparatus. Also, the known device cannot very well be applied to the guidance of connections extending between a frame and a rotatable support of the device in a medical diagnostic apparatus. This is because the frame and the rotatable support both form part of the medical diagnostic apparatus, and a device that guides the connections between the frame and the rotatable support of the apparatus via the ceiling is unnecessarily complicated. These connections may seriously hamper the medical staff, the patient, and the movement of the medical diagnostic apparatus during its operation, such as a rotation of the support relative to the frame, especially in the case of medical diagnostic apparatuses having a wide angular range, in which the connections extending between the frame and the rotatable support are generally longer than those of an apparatus having a more restricted angular range.

It is an object of the invention to provide a medical diagnostic apparatus of the kind mentioned in the opening paragraph that is arranged such that a comparatively simple construction is obtained for the guidance of one or several connections between the frame and the rotatable support.

Said object is achieved by a medical diagnostic apparatus according to the invention, which is characterized in that a chain of interconnected reinforcement elements extending substantially in longitudinal direction of the hose is provided in the hose, wherein consecutive reinforcement elements can mutually rotate about an axis of rotation that is perpendicular to the longitudinal direction of the hose, whereas they are substantially rigidly interconnected in the direction of their axis of rotation. The chain of reinforcement elements provided in the hose here acts as a backbone for the hose and achieves that connections extending between the frame and the rotatable support of the apparatus are guided through the hose in a simple manner without the need for additional guidance, for example via a construction at the ceiling.

An additional advantage is that the chain of reinforcement elements provided in the hose affords the connections between the frame and the rotatable support a certain measure of stiffness, while these connections still remain sufficiently flexible so as not to detract from an optimum freedom of movement of the rotatable support with respect to the frame. Said stiffness prevents uncontrolled movements of the hose and of the connections running through it. It is furthermore possible to cause the hose and the connections running through it to occupy a previously well defined position in space irrespective of the position of the rotatable support relative to the frame, as a result of which interference with the medical staff and the patient by the hose and the connections running through it can be reduced.

Another additional advantage is that the use of a hose through which the connections between the frame and the rotatable support extend protects these connections, so that they are less vulnerable and their useful life can be extended. The medical diagnostic apparatus can also be cleaned more thoroughly and easily due to the use of a hose through which connections extend, so that a higher degree of hygiene is achieved compared with a situation in which no hose is used. Moreover, an aesthetically more attractive appearance of the medical diagnostic apparatus is obtained in this manner.

A practical embodiment of the invention is formed by a medical diagnostic apparatus which is characterized in that the chain of interconnected reinforcement elements extends between the frame and the rotatable support. As a result, no separate measures are necessary for fastening the chain of interconnected reinforcement elements in the hose, which benefits the simplicity of the construction.

A preferred embodiment of the invention is formed by a medical diagnostic apparatus which is characterized in that one or several reinforcement elements is or are each provided with at least one abutment surface such that the chain of interconnected reinforcement elements can rotate in one direction through at most a first angle, while said chain can rotate in a direction opposed to said first direction through at most a second angle, which second angle is smaller than the first angle. The first angle through which the chain can rotate at the farthest is obtained in that the reinforcement elements, each provided with at least one abutment surface, each abut with their abutment surface against a respective adjoining reinforcement element. This first angle is determined by the bending specification of the connections guided through the hose, i.e. by the angle through which the connections can be bent without damage being caused to the connections. The bending specification is connected with the values for the maximum allowable mechanical stresses that can be applied to these connections as specified by the manufacturer of the connections and will in practice usually amount to an angle of approximately 20 to 30°. The second angle is smaller than the first angle and, in a preferred embodiment of the invention, is only a few degrees, for example 3 to 6°, whereby an additional stiffness is imparted to the connections between the frame and the rotatable support. The chain of interconnected reinforcement elements, the latter being substantially rigidly interconnected in the direction of their axis of rotation, provided in the hose gives an additional stiffness. As a result of this, the hose and the connections running through it will occupy positions in space that can be well defined beforehand, irrespective of the position of the rotatable support relative to the frame. The flexibility of the connections that is required for achieving an optimum freedom of movement of the rotatable support relative to the frame is retained thereby. The additional stiffness provided to the connections between the frame and the rotatable support renders it possible to avoid uncontrolled movements of the hose resulting from the forces of gravity, acceleration and torque in the connections. The discomfort to the medical staff and the patient caused by the long connections between the frame and the rotatable support can also be additionally reduced.

An embodiment of the invention is formed by a medical diagnostic apparatus which is characterized in that one or several reinforcement elements is or are each provided with at least two guide elements for guiding the connections between the frame and the rotatable support inside the hose. These guide elements serve to guide the connections through the hose, keeping them in place inside the hose so that they do not get tangled up inside the hose. The guide elements also ensure that the connections inside the hose do not get between the hose and the chain of interconnected reinforcement elements, which could cause damage to the connections.

A further embodiment of the invention is formed by a medical diagnostic apparatus which is characterized in that the reinforcement elements and the guide elements have a rounded shape, as seen in a cross-section perpendicular to the longitudinal direction of the hose, which shape corresponds substantially to the shape of the internal cross-section of the hose taken perpendicularly to the main direction of the hose. An advantage of this is that the reinforcement elements and the guide elements have no sharp corners, at least in a cross-section perpendicular to the longitudinal direction of the hose, which avoids damage to the hose and the connections and prolongs the operational life of the hose and the connections.

A further embodiment of the invention is formed by a medical diagnostic apparatus which is characterized in that the chain of mutually rotatably interconnected reinforcement elements is manufactured from metal or synthetic resin. Not only is a construction of metal or synthetic resin a practical choice, but it is also important that the chain of interconnected reinforcement elements should be capable of supporting and guiding the weight of the connections between the frame and the rotatable support without problems. The weight of the connections is comparatively great in medical diagnostic apparatuses with a comparatively great number of and/or comparatively long connections, and it is advantageous to construct the chain of interconnected reinforcement elements from a strong metal, such as steel. A construction of the chain of interconnected reinforcement elements made of a strong synthetic resin, such as polyamide, will suffice in the case of medical diagnostic apparatuses in which the connections between the frame and the rotatable support are comparatively light.

A further, preferred embodiment of the invention is formed by a medical diagnostic apparatus which is characterized in that the frame of the apparatus is provided with a support framework for supporting the hose. Since the chain of interconnected reinforcement elements can be rotated more or less smoothly in two directions, it is possible in a limited number of positions of the rotatable support with respect to the frame that the hose with the connections running through it will occupy a position in space such that it can collapse. To avoid an undesirable collapse of the hose and the connections running through it, which may inconvenience the medical staff, the frame of the medical diagnostic apparatus is provided with a support framework which supports the hose in such positions of the rotatable support relative to the frame.

A hose according to the invention is characterized in that a chain of interconnected reinforcement elements extending substantially in longitudinal direction of the hose is provided in the hose, wherein consecutive reinforcement elements can mutually rotate about an axis of rotation that is perpendicular to the longitudinal direction of the hose, whereas they are substantially rigidly interconnected in the direction of their axis of rotation.

Embodiments of a medical diagnostic apparatus and a hose according to the invention will be discussed in more detail with reference to the appended Figures, in which:

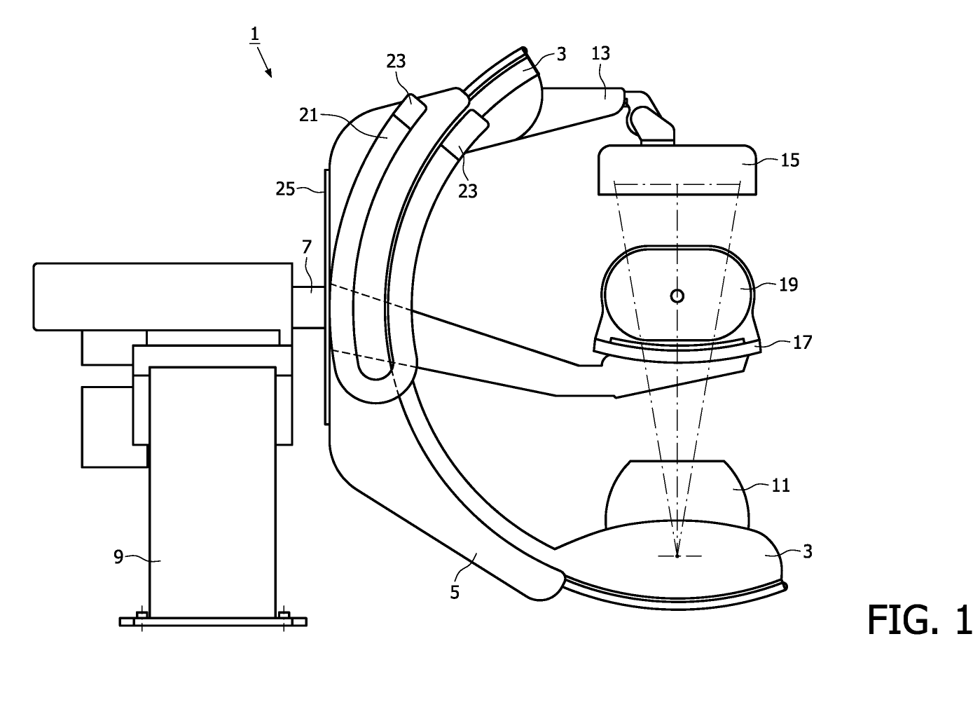

FIG. 1 diagrammatically shows an embodiment of a medical diagnostic apparatus according to the invention in side elevation,

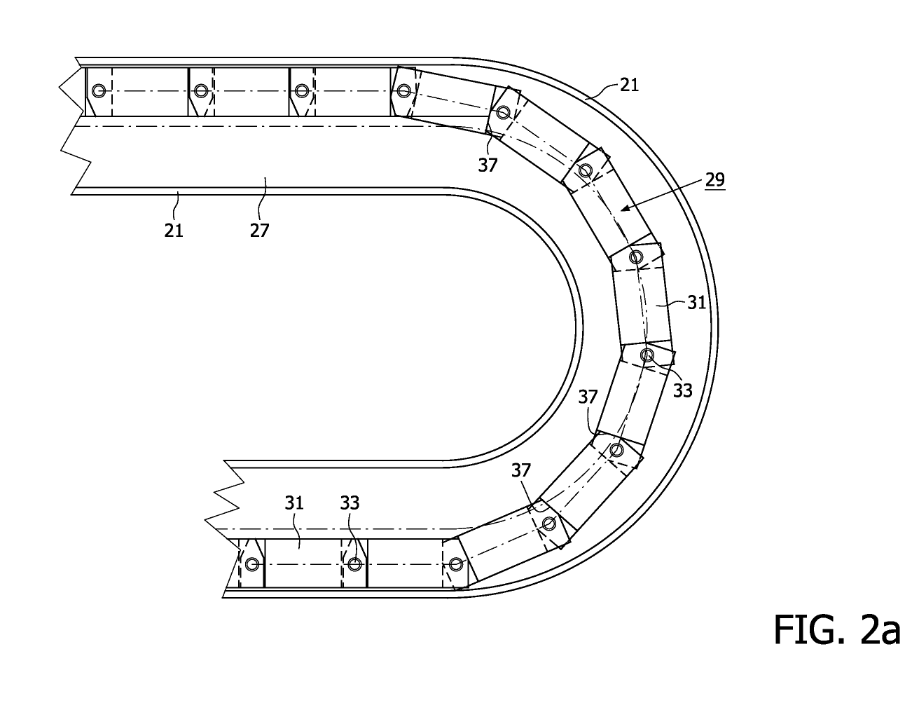

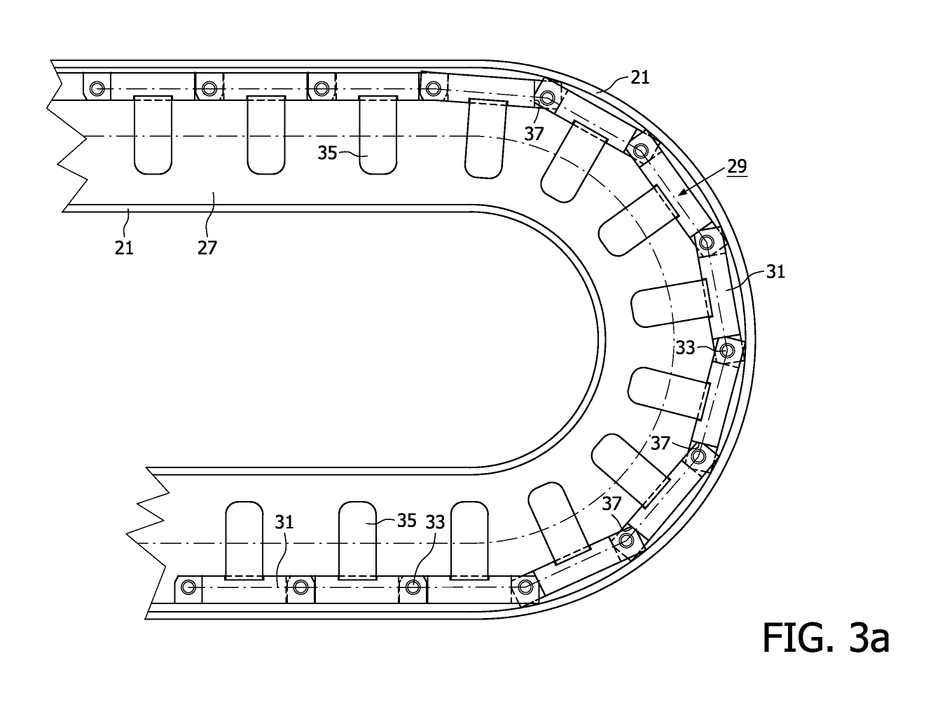

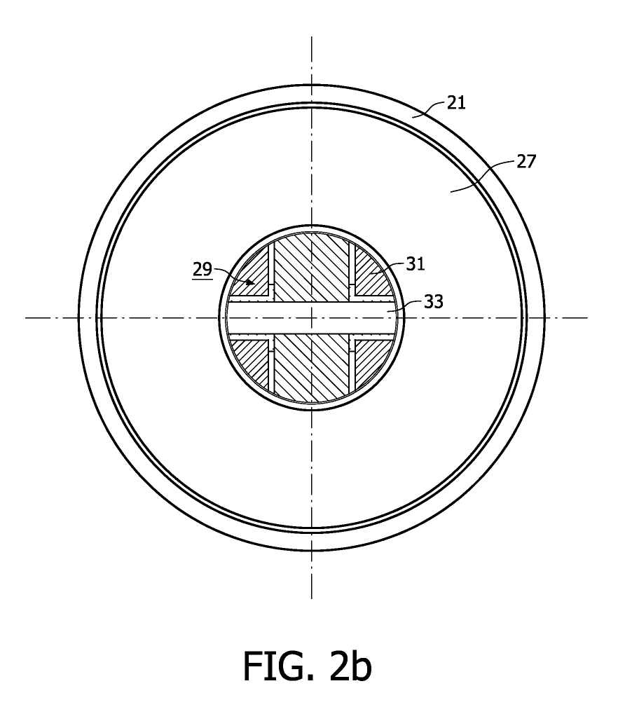

FIG. 2a diagrammatically shows a first embodiment of a hose according to the invention in side elevation,

FIG. 2b diagrammatically shows the first embodiment of a hose according to the invention in cross-section,

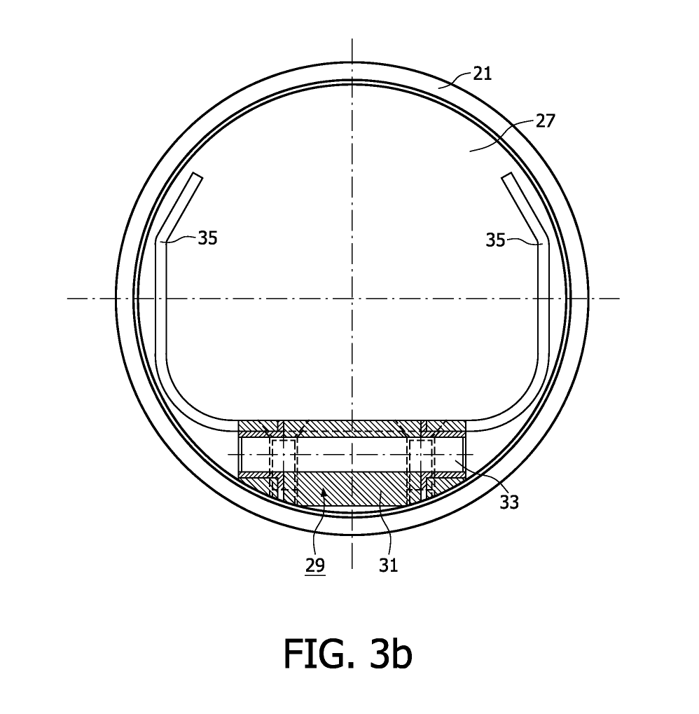

FIG. 3a diagrammatically shows a second embodiment of a hose according to the invention in side elevation,

FIG. 3b diagrammatically shows the second embodiment of a hose according to the invention in cross-section.

FIG. 1 diagrammatically shows an embodiment of a medical diagnostic apparatus according to the invention in side elevation. In the embodiment shown, the medical diagnostic apparatus is an X-ray apparatus. The X-ray apparatus 1 is provided with a rotatable support or C-arm 3 and a frame 5 which guides the C-arm 3 and relative to which the C-arm 3 can be rotated. The frame 5 can rotate about a horizontal axis shaft 7 and is connected via this shaft 7 to a stand 9 that is placed on the floor. An X-ray source with collimator 11 is fastened to one end of the C-arm 3, and an X-ray detector 15, which is to be located diametrically opposite the X-ray source, is fastened to the other end of the C-arm 3 by means of a flexible arm 13. The X-ray source with collimator 11 and the X-ray detector 15 are put in position with respect to a patient table 17 and a patient 19 in that the frame 5 is rotated about the horizontal shaft 7 and the C-arm 3 is rotated relative to the frame 5. Furthermore, the X-ray apparatus 1 is provided with a hose 21 which extends between the C-arm 3 and the frame 5 and which is fastened by fastening means 23 to the C-arm 3 and the frame 5. The hose 21 is provided with a chain of interconnected reinforcement elements (not shown in FIG. 1) that extend in the longitudinal direction of the hose 21 and that are mutually rotatable about an axis that is perpendicular to the longitudinal direction of the hose 21, whereas they are substantially rigidly connected in the direction of their axis of rotation. The expression “substantially rigidly” is to be understood in the sense that a certain amount of mechanical play is allowed. The chain of reinforcement elements here acts as a kind of backbone for the hose 21.

The X-ray apparatus 1 is further provided with a support framework 25 fastened to the frame 5 and capable of supporting the hose 21, the chain of reinforcement elements present therein, and the connections extending between the C-arm 3 and the frame 5 in certain positions of the C-arm 3.

Normally, a plurality of connections extend between the C-arm 3 and the frame 5, such as electrical supply cables for the detector 15, for the motors (not shown in FIG. 1) for positioning the frame 5 and the C-arm 3, for driving the blades of the collimator, for the viewfinder (not shown in FIG. 1), and for the collision protection mechanism (not shown in FIG. 1) that is to prevent the detector 15 from hitting the patient 19. Other connections between the frame 5 and the C-arm 3 are, for example, high-voltage cables for supplying the high voltage between the cathode and anode of the X-ray source 11 and tubes through which a liquid can be passed for cooling the X-ray source 11 and/or the detector 15. The guiding of all these connections through a hose 21 provided with a chain of interconnected reinforcement elements acting as a backbone results in a comparatively simple construction in which the hose 21 with the connections running through it will not make any uncontrolled movements such as, for example, flapping movements, by which the medical staff or the patient 19 can be hindered.

The use of a hose 21 with a backbone is highly favorable especially in the case of X-ray apparatuses having a wide angular range for enabling 3D reconstructions of a patient 19 of good quality to be made, for example in cardiovascular applications of the X-ray apparatus 1. Indeed, the general rule is that the greater the angular range of the C-arm 3, the longer the connections between the C-arm 3 and the frame 5 will be, and thus the greater the risk of uncontrolled movements of the connections and inconvenience to the medical staff and the patient. The implementation of the invention avoids such uncontrolled movements and inconvenience. The backbone of the hose will preferably be made of steel here because of the fact that the connections between the C-arm 3 and the frame 5 are comparatively long in such a case, so that the weight of the connections is comparatively great. A particularly favorable application of the invention is its use in an X-ray apparatus provided with a so-termed Z-drive system as described in WO 2005/058163. Very wide angular ranges of up to 200° or even 210° are possible with such X-ray apparatuses, which means that the connections between the frame and the C-arm are particularly long and cause considerable inconvenience to the medical staff as well as the patient because of this wide angular range.

Another factor is that the general hygiene in the use of the X-ray apparatus 1 is enhanced when the invention is implemented. This is because the invention avoids the situation that the connections between the C-arm 3 and the frame 5 slide over the floor at one moment and hang above the patient 19 the next moment during use of the X-ray apparatus 1, with the result that impurities from the floor can be transferred to the patient, which is especially undesirable in surgical applications of the X-ray apparatus 1. The fact that uncontrolled movements of the hose 21 are avoided with the use of the invention, moreover, prevents the hose 21 from hitting against the detector 15 or other components of the apparatus 1 during operation thereof, whereby the switches of the collision protection mechanism present on the apparatus could be incorrectly activated. The collision protection mechanism serves to avoid collisions between the X-ray apparatus and the patient or between the X-ray apparatus and the operator thereof. An incorrect activation of the switches of the collision protection mechanism leads to an undesirable termination of an ongoing diagnostic examination. The use of a hose 21 through which the connections between the C-arm 3 and the frame 5 are passed has the further result that the X-ray apparatus 1 can be cleaned more thoroughly and simply than if the connections were not guided through a hose 21. Obviously, a hose 21 has an outer surface that can be easily cleaned. To give the hose 21 a certain degree of sturdiness, however, it is preferably constructed with a ribbed wall. A maximum possible volume remains available inside the hose 21 as a result of this for guiding the connections between the C-arm 3 and the frame 5. Cleaning the ribbed outer surface of the hose 21 is indeed somewhat more difficult than if the hose 21 were to have a smooth outer surface, but cleaning a hose with a ribbed outer surface is considerably more convenient than cleaning the individual connections between the C-arm 3 and the frame 5.

FIG. 2a diagrammatically shows a first embodiment of a hose according to the invention in side elevation. Inside the hose 21 there is the chain 29 of interconnected reinforcement elements 31 extending in the longitudinal direction of the hose, which chain in this embodiment is formed by a succession of cylindrical reinforcement elements 31. These cylindrical reinforcement elements 31 are mutually rotatably interconnected by links 33 which are perpendicular to the longitudinal direction of the hose 21. The cylindrical reinforcement elements 31 are further provided with abutment surfaces 37 which abut against respective adjoining cylindrical reinforcement elements 31 and thus define the maximum angle through which the chain 29 of reinforcement elements 31 can be rotated. The first embodiment shown in FIG. 2a has links 33 formed by pins. The chain 29 of reinforcement elements 31 extends between the C-arm (not shown in FIG. 2a) and the frame of the X-ray apparatus. One end of the chain 29 is fastened to the C-arm by fastening means (not shown), while the other end of the chain 29 is fastened to the frame. The volume 27 inside the hose 21 not occupied by the chain 29 of interconnected reinforcement elements 31 is available for guiding the connections.

FIG. 2b diagrammatically shows the first embodiment of a hose according to the invention in a cross-section taken perpendicularly to the longitudinal direction of the hose. It shows a cross-section of one of the cylindrical reinforcement elements 31, from which the chain 29 of reinforcement elements is built up in the first embodiment, in the center of the hose 21 and in the center of the volume 27 available for the connections. FIG. 2b also shows the links 33 by means of which the cylindrical reinforcement elements 31 are mutually rotatably interconnected and which accordingly constitute the axis of rotation of the relevant reinforcement element 31. It is not necessary for the chain 29 of cylindrical reinforcement elements 31 to be centrally located in the hose 21 because there is hardly any risk of damage to the connections running through the hose 21 owing to the rounded shape of the cylindrical reinforcement elements 31.

FIG. 3a diagrammatically shows a second embodiment of a hose 21 according to the invention in side elevation. In this second embodiment, the chain 29 of interconnected reinforcement elements 31 extending in the longitudinal direction of the hose 21 is formed by a succession 29 of rounded, rectangular reinforcement elements 31 which are each provided with at least two guide elements 35. The rounded, rectangular reinforcement elements 31 are mutually rotatably interconnected by means of links 33 which are perpendicular to the longitudinal direction of the hose. The rounded, rectangular reinforcement elements 31, moreover, are provided with abutment surfaces 37 which abut against respective adjoining reinforcement elements 31 and thus define a maximum angle through which the chain 29 of reinforcement elements 31 can be rotated. As in the first embodiment, the links 33 are formed by pins in the second embodiment. Again, the chain 29 of interconnected reinforcement elements 31 extends between the C-arm (not shown in FIG. 3a) and the frame of the X-ray apparatus, and the chain 29 is fastened at one end to the C-arm and at the other end to the frame. The volume 27 inside the hose 21 enclosed by the chain 29 of reinforcement elements 31 and the associated guide elements 35 is available for guiding the connections.

FIG. 3b diagrammatically shows the second embodiment of a hose according to the invention in a cross-section which is perpendicular to the longitudinal direction of the hose. Unlike the cylindrical reinforcement element of the first embodiment, the rounded, rectangular reinforcement element 31 shown in cross-section here is not centrally located in the hose 21, but at one side of the hose 21. It is achieved thereby that the volume 27 which is enclosed by the reinforcement elements 31 and the guide elements 35 inside the hose 21 and is accordingly available for the connections is as large as possible. The guide elements 35 ensure that the connections inside the hose 21 remain in place so that they do not get tangled up. The guide elements 35 also ensure that the connections in the hose 21 cannot enter between the hose 21 and the chain 29, which could damage the connections. The rounded cross-sectional shape of the reinforcement elements 31 and the guide elements 35, which corresponds to the shape of the internal cross-section of the hose 21, prevents damage to the hose 21 and the connections, thus prolonging the useful life of the hose and the connections. FIG. 3b also shows the link 33 by means of which the rounded, rectangular reinforcement elements 31 are mutually rotatably interconnected and which accordingly define the axis of rotation of the relevant reinforcement element 31.

In X-ray apparatuses with comparatively many and/or comparatively long connections, the weight of these connections will be comparatively great, and the chain 29 of interconnected reinforcement elements 31 with guide elements 35 is preferably constructed from steel. The pins 33, which interconnect the reinforcement elements 31 with mutual rotation possibility, will be separate pins in that case and will not be integral with the reinforcement element 31. These pins 33 are also made of steel and are passed transversely through the reinforcement elements 31, which they interconnect, with interposed bearing bushes which are also made of steel or synthetic resin and on which considerable forces can be exerted.

In X-ray apparatuses in which the connections between the frame and the rotatable support are comparatively light, a design of the chain 29 of interconnected reinforcement elements 31 will suffice which is made of a sturdy synthetic resin. In such cases, in which much lesser forces are exerted on the connections 33 than in the case of comparatively many and/or comparatively long connections, a chain 29 of interconnected reinforcement elements 31 may be used with guide elements manufactured by injection molding. There are no separate links 33 any more then, but links 33 integrated with the reinforcement elements 31. The reinforcement elements 31 then each comprise one or more pins 33 around which a subsequent reinforcement element 31 of the chain 29 can get a grip. Such loose chains 29 of injection-molded, mutually rotatably interconnected reinforcement elements 31 with integral pins 33, whether or not provided with guide elements 35, are commercially available from companies such as IGUS® in Germany and CPS Busan in Korea. It should be noted in this connection, however, that these commercially available chains 29 are not suitable for use in a hose 21 because these chains 29 of mutually rotatably interconnected reinforcement elements 31, whether or not provided with guide elements 35, are in general not provided with a rounded shape corresponding to the internal cross-section of a hose 21, with the result that the hose 21 and the connections running through the hose 21 may be damaged.

1. A medical diagnostic apparatus (1) comprising a frame (5), a rotatable support (3), at least one connection extending between the frame and the support, and a hose (21) for guiding said connection, characterized in that a chain (29) of interconnected reinforcement elements (31) extending substantially in longitudinal direction of the hose is provided in the hose (21), wherein consecutive reinforcement elements can mutually rotate about an axis of rotation that is perpendicular to the longitudinal direction of the hose, whereas they are substantially rigidly interconnected in the direction of their axis of rotation.

2. A medical diagnostic apparatus (1) as claimed in claim 1, characterized in that the chain (29) of interconnected reinforcement elements (31) extends between the frame (5) and the rotatable support (3).

3. A medical diagnostic apparatus (1) as claimed in claim 1, characterized in that one or several reinforcement elements (31) is or are each provided with at least one abutment surface (37) such that the chain (29) of interconnected reinforcement elements (31) can rotate in one direction through at most a first angle, while said chain can rotate in a direction opposed to said first direction through at most a second angle smaller than the first angle.

4. A medical diagnostic apparatus (1) as claimed in claim 1, characterized in that one or several reinforcement elements (31) is or are each provided with at least two guide elements (35) for guiding the connections between the frame (5) and the rotatable support (3) inside the hose (21).

5. A medical diagnostic apparatus (1) as claimed in claim 4, characterized in that the reinforcement elements (31) and the guide elements (35) have a rounded shape, as seen in a cross-section perpendicular to the longitudinal direction of the hose (21), which shape corresponds substantially to the shape of the internal cross-section of the hose taken perpendicularly to the main direction of the hose (21).

6. A medical diagnostic apparatus (1) as claimed in claim 1, characterized in that the chain of mutually rotatably interconnected reinforcement elements is manufactured from metal or synthetic resin.

7. A medical diagnostic apparatus (1) as claimed in claim 1, characterized in that the frame (5) of the apparatus is provided with a support framework (25) for supporting the hose (21).

8. A medical diagnostic apparatus (1) as claimed in claim 1, characterized in that said medical diagnostic apparatus is an X-ray apparatus.

9. A hose (21) suitable for guiding at least one connection in a medical diagnostic apparatus (1) as claimed in claim 1, characterized in that a chain (29) of interconnected reinforcement elements (31) extending substantially in longitudinal direction of the hose is provided in the hose (21), wherein consecutive reinforcement elements can mutually rotate about an axis of rotation that is perpendicular to the longitudinal direction of the hose, whereas they are substantially rigidly interconnected in the direction of their axis of rotation.
